(19) United States
(12) Patent Application Publication
(10) Pub. No.: US 2020/0178003 A1
(43) Pub. Date: Jun. 4, 2020

(54) HEARING DEVICE WITH ACOUSTICALLY CONNECTED CHAMBERS AND METHOD OF ITS OPERATION

(71) Applicant: Sonova AG

(72) Inventors: Thomas Zurbruegg, Frauenfeld (CH); Antonio Hoelzl, Zurich (CH); Paul Wagner, Meilen (CH); Fabian Hohl, Hombrechtikon (CH)

(21) Appl. No.: 16/695,220

(22) Filed: Nov. 26, 2019

(30) Foreign Application Priority Data
Dec. 4, 2018 (EP) 1820995.80

(51) Int. Cl. H04R 25/00

(52) U.S. Cl. CPC H04R 25/456; H04R 25/604

(57) ABSTRACT

The disclosure relates to hearing device comprising a housing accommodating an acoustic transducer separating an inner volume inside the housing into a first chamber and a second chamber acoustically coupled by an oscillator element of the acoustic transducer. A first acoustic port acoustically couples the first chamber to an ambient environment outside the inner volume.

### TECHNICAL FIELD

This disclosure generally relates to a hearing device, and more specifically to a hearing device comprising an acoustic transducer acoustically coupling a first chamber and a second chamber inside a housing of the hearing device.

### BACKGROUND

Hearing devices may be used to improve the hearing capability or communication capability of a user, for instance by compensating a hearing loss of a hearing-impaired user, in which case the hearing device is commonly referred to as a hearing instrument such as a hearing aid, or hearing prosthesis. A hearing device may also be used to produce a sound in a user's ear canal. Sound may be communicated by a wire or wirelessly to a hearing device, which may reproduce the sound in the user's ear canal. For example, earpieces such as earbuds, earphones or the like may be used to generate sound in a person's ear canal. Furthermore, hearing devices may be employed as hearing protection devices that suppress or at least substantially attenuate loud sounds and noises that could harm or even damage the user's sense of hearing. Hearing devices are often employed in conjunction with communication devices, such as smartphones, for instance when listening to sound data processed by the communication device and/or during a phone conversation operated by the communication device. More recently, communication devices have been integrated with hearing devices such that the hearing devices at least partially comprise the functionality of those communication devices.

Hearing devices can comprise a housing accommodating an acoustic transducer. The acoustic transducer typically comprises an oscillator element driven by an electromagnetic circuit and configured to produce sound waves. For instance, the oscillator element can be a diaphragm or any other vibrational body and/or substance configured to radiate sound waves by moving back and forth in a surrounding propagation medium, such as air. Different types of hearing devices can be distinguished by the position at which the housing is intended to be worn relative to an ear canal of the user. Hearing devices which are configured such that the housing enclosing the transducer can be at least partially inserted into the ear canal can include, for instance, earbuds, earphones, and hearing instruments such as receiver-in-the-canal (RIC) hearing aids, in-the-ear (ITE) hearing aids, invisible-in-the-canal (IIC) hearing aids, and completely-in-the-canal (CIC) hearing aids. The housing can be an earpiece adapted for an insertion and/or a partial insertion into the ear canal. Some hearing devices comprise a housing having a standardized shape intended to fit into a variety of ear canals of different users. Other hearing devices comprise a housing having a customized shape adapted to an ear canal of an individual user. The customized housing can be a shell, in particular a shell of a hearing instrument. The shell can be formed, for instance, from an ear mould.

Acoustic characteristics of a hearing device can depend on various parameters including the geometry of the housing and the size and position of the acoustic transducer inside the housing. A hearing device with a housing enclosing two chambers separated by an acoustic transducer is disclosed in EP 3 177 033 A1. The chambers are acoustically coupled to an ambient environment outside the housing by an acoustic port. The hearing device can thus be customized to desired characteristics, for instance to provide a particular frequency response and/or output impedance and/or pressure equalization of the hearing device. The acoustic characteristics can be further adapted by an acoustic resistance operating in parallel to the acoustic port. Another hearing device with a housing enclosing two chambers separated by an acoustic transducer is disclosed in EP 3 035 700 A1.

Accordingly, there exists a need to provide for an improved hearing device.

### SUMMARY

Those customized acoustic characteristics of the hearing device, however, as defined by a fixed effective size of the acoustic ports and/or a fixed value of the acoustic resistance provided in the housing, can only provide for a static acoustic configuration of a sound reproduced by the hearing device. But a sound reproduction that would be perceived as ideal by a wearer of the hearing device can depend on an actual hearing situation. An optimized sound perception can change during wearing of the hearing device and can also depend on personal characteristics and preferences of the wearer. The perceived sound can also vary due to differing sound processing schemes applied to an audio signal reproduced by the acoustic transducer and/or due to unwanted changes of a coupling of the hearing device to the ear canal, for instance when the housing is placed in different positions inside the ear canal. Those changes of the sound perception cannot be accounted for by statically predefined acoustic characteristics of the hearing device, at least not to a desirable extent.

It is an object of the present disclosure to avoid at least one of the above mentioned disadvantages and to allow a less restricted adaptability of acoustic characteristics of the hearing device, in particular with regard to varying hearing situations and/or altering user preferences and/or differing user properties. It is another object to allow a repeatable and/or continuous modification of the acoustic characteristics, in particular while using the hearing device at a wearing position at a user's ear. It is a further object to allow an improved wearing comfort and/or listening experience for the user of the hearing device. It is another object to increase a possible range of applications of the hearing device, in particular such that the hearing device is adaptable to diverse everyday hearing situations and/or to exceptional events requiring a rather specific configuration of the acoustic characteristics.

At least one of these objects can be achieved by a hearing device comprising the features of patent claim 1 and/or a method of operating the hearing device comprising the features of patent claim 15 and/or by a computer-readable medium comprising the features of patent claim 16.

Accordingly, the disclosure proposes a hearing device comprising a housing configured to be at least partially inserted into an ear canal, and an acoustic transducer having an oscillator element configured to produce sound waves. The housing accommodates the acoustic transducer such that the oscillator element separates an inner volume inside the housing into a first chamber and a second chamber. The first chamber and the second chamber are acoustically coupled by the oscillator element. The hearing device further comprises a sound outlet configured to release sound waves into the ear canal. The hearing device also comprises a first acoustic port and a second acoustic port. The first acoustic port acoustically couples the first chamber to an ambient environment, in particular outside the inner volume. The second acoustic port acoustically couples the second chamber to the first chamber or to the ambient environment. The hearing device also comprises an acoustic actuator. The acoustic actuator can be provided at the first acoustic port or the second acoustic port. The acoustic actuator is configured to change an acoustic property of the first acoustic port or the second acoustic port. The actuator can actively modify the acoustic properties (or a single property). For example, the actuator can adjust the impedance of the first or second port based on detecting that a hearing device is detecting wind noise, and when the wind noise is no longer detected, the actuator can re-adjust the impedance. As another example, the actuator can actively modify the acoustic property or properties of a first, second, or third port based on receiving input from a user or based on detecting a user's own voice. The acoustic property or properties can be modified to provide a sound that more intelligible to a person with hearing loss (e.g., less echo, cleaner, different frequencies that the user can hear better).

Acoustic characteristics of the sound output of the hearing device can thus be set in a rather comprehensive and effective way by providing an acoustic communication of the first chamber and the second chamber with the ambient environment and by further employing at least one acoustic actuator for a variable adjustment of the acoustic communication with the ambient environment in order to modify the acoustic characteristics. The setting of the acoustic characteristics can be exploited for a more pleasant sound perception in different hearing situations. For instance, the different hearing situations can include streaming, such as streaming of music or a television program, where it can be desirable to specify the acoustic impedance to yield full bandwidth sound delivery; noisy scenes, such as during travelling in a plane, and/or streaming in noisy scenes, where it can be desirable to specify the acoustic impedance for an attenuation of a direct sound, an optimal passive and/or active noise reduction and sound cleaning; and low input level scenes, in particular in conjunction with compressive settings in which insertion gain can be large, where it can be desirable to specify the acoustic impedance to avoid feedback. The different hearing situations can further include conversations of the wearer of the hearing device with another person including a conversation in a rather quiet setting; a conversation in noise, for instance a communication in a restaurant; a communication in noise, for instance during a phone call in noisy environments; and a conversation during streaming, for instance during watching a television program and/or listening to music while having a conversation with a partner.

Wearing the hearing device in the ear canal can cause a sealing of an inner ear canal region with respect to the ambient environment outside the ear canal. Sealing the ear canal can be beneficial, on the one hand, to allow a more direct and/or less disturbed sound delivery of the sound produced by the acoustic transducer into the ear, in particular by avoiding a negative impact of environmental sounds occurring in the ambient environment. On the other hand, sealing the ear canal can create an occlusion effect in the ear canal, whereby the hearing device wearer may perceive “hollow” or “booming” echo-like sounds. The occlusion effect can be caused by bone-conducted sound vibrations reverberating in the sealed inner region of the ear canal, so that speaking, chewing, body movement, heart beat or the like may create echoes or reverberations in the inner region. Occlusion can occur when an atmospheric connection between the inner region of the ear canal and the ambient environment outside the ear canal is strongly reduced or cut off such that no pressure equalisation in between the isolated regions can take place. Compared to a completely open ear canal, the occlusion effect can boost low frequency sound pressure in the ear canal by 20 decibels (dB) or more resulting in an undesirable loud perception of low frequencies, in particular below 500 Hertz (Hz). In some implementations, the setting of the characteristics of the hearing device according to the present disclosure can be exploited for adjusting an amount in which the sealing of the inner ear canal region takes place, in particular to comply with varying hearing situations including conversations of the user using his own voice and/or rather pure listening situations.

The disclosure also proposes a method of operating the hearing device. The method comprises controlling the acoustic actuator to change the acoustic property of the first acoustic port or the second acoustic port. The disclosure also proposes a computer-readable medium, in particular a non-transitory computer-readable medium. The computer-readable medium stores instructions that, when executed by a processor, cause the hearing device to perform operations of the method. Features regarding some implementations of the hearing device, in particular as further detailed in the subsequent description, may be correspondingly applied in some implementations of the method for operating the hearing device and/or the computer readable medium. Aspects regarding some implementations of the method for operating the hearing device, in particular as further detailed in the subsequent description, may be correspondingly applied in some implementations of the hearing device and/or the computer readable medium.

A characteristic parameter of the acoustic properties of the hearing device can be determined by its acoustic impedance. Generally, the acoustic impedance can be a measure of the opposition to an acoustic flow along an acoustic path inside the housing resulting in an acoustic pressure applied to an inner volume of housing. The output impedance can be the acoustic impedance measurable at the sound outlet. It is desirable to adjust the acoustic impedance in such a way that an optimized hearing perception for a wearer of the hearing device can be achieved. The inner volume inside the housing can provide an acoustic pathway for sound waves produced from the oscillator element. The acoustic actuator can be configured to adjust an acoustic impedance of the acoustic pathway by the changing the acoustic property of the first acoustic port or the second acoustic port. In this way, an output impedance and/or a frequency response of the sound waves released from the sound outlet can be adjusted, in particular with respect to varying hearing situations.

In some implementations, the acoustic actuator is a first acoustic actuator and the hearing device comprises a second acoustic actuator. The first acoustic actuator can be provided at the first acoustic port. The second acoustic actuator can be provided at the second acoustic port. The first acoustic actuator can be configured to change an acoustic property of the first acoustic port. The second acoustic actuator can be configured to change an acoustic property of the second acoustic port. The extent and freedom for variably adjusting the acoustic characteristics of the sound output of the hearing device can thus be further improved by providing a first adjusting option at the first acoustic port and a second adjusting option at the second acoustic port.

In some implementations, the hearing device comprises a third acoustic port. The third acoustic port can provide an acoustical coupling between the second chamber and the first chamber. The second acoustic port can provide an acoustical coupling between the second chamber and the ambient environment. The first acoustic port can provide an acoustical coupling between the first chamber and the ambient environment. By acoustically coupling the first chamber and the second chamber with each other and by acoustically coupling each of the first chamber and the second chamber to the ambient environment, a rather homogeneous coupling of the inner volume inside the housing to the ambient environment can be realized. This can be exploited, on the one hand, to configure the hearing device such that the released sound waves match desired characteristics, in particular with respect to an output impedance of the hearing device. On the other hand, the adjustability of the released sound to varying hearing situations can be further improved. In some implementations, a third acoustic actuator is provided at the third acoustic port. The third acoustic actuator can be configured to change an acoustic property of the third acoustic port. The three acoustic actuators at the acoustic ports distributed along the acoustic pathway inside the housing can provide an effective impact on the characteristics of the released sound and can also account for an adjustability of the sound characteristics on a large scale.

In some implementations, the first acoustic port is provided in a housing portion enclosing the first chamber. In some implementations, the second acoustic port is provided in a housing portion enclosing the second chamber. In some implementations, the second acoustic port is provided in a partition separating the first chamber and the second chamber. In some implementations, the third acoustic port is provided in a partition separating the first chamber and the second chamber. The partition can comprise the oscillator element of the acoustic transducer. In some implementations, the sound outlet is provided at a housing portion enclosing the second chamber, in particular at a rear wall and/or a side wall of the housing. In some implementations, the sound outlet is provided at a housing portion enclosing the first chamber, in particular at a rear wall and/or a side wall of the housing.

In some implementations, at least one of the first acoustic port, second acoustic port, and third acoustic port comprises an aperture through which the acoustic coupling is provided.

The aperture can be provided by a tubular member including an opening. The aperture can define an acoustic mass of the acoustic port. In particular, a length and/or cross section of the tubular member can be selected such that a desired acoustic mass is provided at the acoustic port. In some implementations, at least one of the first acoustic port, second acoustic port, and third acoustic port comprises an oscillator element through which the acoustic coupling is provided. The oscillator element can be provided in the aperture. The oscillator element can be a membrane, a diaphragm, and/or the like. The oscillator element can further define an acoustic mass of the acoustic port. In particular, a mass and/or surface area and/or suspension of the oscillator element can be selected such that a desired acoustic mass is provided at the acoustic port. In this way, the acoustic properties and/or a range of the acoustic properties that can be changed at the acoustic port by the acoustic actuator can be specified by the thus defined acoustic mass of the acoustic port.

In some implementations, the hearing device comprises an acoustic resistance. The acoustic resistance can comprise a first terminal and a second terminal. The acoustic resistance can be configured to attenuate sound waves propagating between the first terminal and the second terminal, in particular a sound pressure of the sound waves. To this end, the acoustic resistance can comprise a sound resistive body between the first terminal and the second terminal. The sound resistive body can comprise, for instance, a grid structure such as a wire mesh and/or a damping material such as a cloth. In some implementations, the first terminal and the second terminal of the acoustic resistance are positioned such that they provide an acoustical coupling between two volume portions corresponding to the volume portions acoustically coupled by the first acoustic port or by the second acoustic port. In particular, the volume portions acoustically coupled by the first acoustic port can be the first chamber and the ambient environment. The volume portions acoustically coupled by the second acoustic port can be the second chamber and the first chamber. The volume portions acoustically coupled by the second acoustic port can be the second chamber and the ambient environment. The volume portions acoustically coupled by a third acoustic port can be the second chamber and the first chamber. The acoustic resistance can provide a customization of acoustic properties at the acoustic pathway inside the housing, in particular with respect to a desired frequency response and/or output impedance.

In some implementations, the acoustic resistance is provided at the first acoustic port or at the second acoustic port. The acoustic resistance can be provided at the acoustic port at which the acoustic actuator is provided. Thus, the acoustic resistance can be connected in series with the acoustic actuator. In this way, the acoustic properties and/or a range of the acoustic properties that can be changed at the acoustic port by the acoustic actuator can be specified by the acoustic resistance. In particular, the acoustic actuator and the acoustic resistance can be provided at the first acoustic port. The acoustic actuator and the acoustic resistance can also be provided at the second acoustic port.

In some implementations, the acoustic resistance is provided in a housing portion enclosing the first chamber at a distance to the first acoustic port or in a housing portion enclosing the second chamber at a distance to the second acoustic port. Thus, the acoustic resistance can be provided in parallel to the respective acoustic port acoustically coupling the inner volume with the ambient environment. In some implementations, the acoustic resistance is provided in a partition between the first chamber and the second chamber at a distance to the acoustic port between the first chamber and the second chamber. Thus, the acoustic resistance can be provided in parallel to the acoustic port acoustically coupling the first chamber and the second chamber. The acoustic resistance can thus also be provided in parallel to the acoustic actuator provided at the respective acoustic port. In this way, the acoustic resistance can be employed to specify acoustic properties of the acoustic pathway inside the housing at a position remote from the acoustic port, in particular static acoustic properties at a position distant from a direct influence of the acoustic actuator at the acoustic port.

In some implementations, the hearing device comprises a first acoustic resistance and a second acoustic resistance. A first terminal and a second terminal of the first acoustic resistance can be positioned such that they provide the acoustical coupling between the two volume portions corresponding to the volume portions acoustically coupled by the first acoustic port. The volume portions acoustically coupled by the first acoustic resistance can thus comprise the first chamber and the ambient environment. The first terminal and the second terminal of the second acoustic resistance can be positioned such that they provide the acoustical coupling between the two volume portions corresponding to the volume portions acoustically coupled by the second acoustic port. The volume portions acoustically coupled by the second acoustic resistance can thus comprise the second chamber and the first chamber or the ambient environment. In some implementations, the hearing device comprises a third acoustic resistance. A first terminal and a second terminal of the third acoustic resistance can be positioned such that they provide the acoustical coupling between the two volume portions corresponding to the volume portions acoustically coupled by the third acoustic port. The volume portions acoustically coupled by the third acoustic resistance can thus comprise the second chamber and the first chamber. In this way, the acoustic pathway inside the housing can be configured with desired acoustic properties at various positions.

In some implementations, the hearing device comprises a first acoustic resistance and a second acoustic resistance. The first acoustic resistance can be provided in parallel to an acoustic port, in particular the first acoustic port or the second acoustic port or the third acoustic port, and the second acoustic resistance can be provided at the acoustic port, in particular in series with an acoustic actuator provided at the acoustic port. In some implementations, the hearing device further comprises a third acoustic resistance and a fourth acoustic resistance. The third acoustic resistance can be provided in parallel to a different acoustic port than the first acoustic resistance and the fourth acoustic resistance can be provided at a different acoustic port than the second acoustic resistance, in particular in series with an acoustic actuator provided at the acoustic port. In some implementations, the hearing device further comprises a fifth acoustic resistance and a sixth acoustic resistance. The fifth acoustic resistance can be provided in parallel to a different acoustic port than the first acoustic resistance and the third acoustic resistance and the sixth acoustic resistance can be provided at a different acoustic port than the second acoustic resistance and the fourth acoustic resistance, in particular in series with an acoustic actuator provided at the acoustic port. The advantages of providing the acoustic resistance in a parallel configuration and in a series configuration relative to the acoustic actuator can thus be combined providing a more refined way of configuring static acoustic properties and adjustable acoustic properties at the acoustic pathway.

In some implementations, the acoustic actuator is an acoustic valve. The acoustic valve can be configured to adjust an effective size of an acoustic port, in particular the first acoustic port or the second acoustic port or the third acoustic port. The changing of the acoustic property can comprise the adjusting of the effective size. The effective size of the acoustic port can be defined as any parameter or combination of parameters on which an efficiency of the acoustic coupling, in particular a venting through the acoustic port, may depend. In some implementations, at least one parameter of the effective size of the acoustic port comprises a cross sectional size and/or length of the acoustic port. The adjustment of the acoustic port can comprise an enlarging and/or reducing of the cross sectional size and/or length of the acoustic port. In some implementations, at least one parameter of the effective size can be a ratio between a cross section and a length of the acoustic port. The adjusting of the effective size can comprise an enlarging and/or reducing of the ratio. In some implementations, at least one parameter of the effective size can be a parameter determining an acoustic mass and/or an acoustic impedance inside the acoustic port. The adjusting of the effective size can comprise an enlarging and/or reducing of the acoustic mass and/or an acoustic impedance. In some implementations, at least one parameter of the effective size can be a parameter determining the mobility of a medium inside the acoustic port. The adjustment of the acoustic port can comprise an enlarging and/or reducing of the mobility of the medium. The adjustment of the effective size of the acoustic port can comprise at least any combination of an enlarging and/or reducing of these parameters of the effective size. In some implementations, the acoustic valve comprises at least one tubular member configured to be displaced at the acoustic port such that an opening size of the acoustic port can be adjusted by the displacement of the tubular member.

In some implementations, the acoustic actuator is an acoustic transducer, in particular an additional acoustic transducer in addition to the other acoustic transducer inside the housing. The acoustic transducer can be configured to produce sound, in particular in addition to the sound waves produced by the at least one other acoustic transducer inside the housing. The changing of the acoustic property of the acoustic port can thus comprise changing the sound produced by the acoustic actuator. In this way, acoustic properties of the acoustic pathway inside the housing, in particular a sound pressure and/or a frequency content and/or an acoustic impedance, can be adjusted, in particular depending on varying hearing situations. Thus, the sound waves released through the sound outlet can be adjusted correspondingly, in particular with regard to a desired output impedance and/or frequency output.

In some implementations, the first acoustic actuator and/or the second acoustic actuator and/or the third acoustic actuator comprises an acoustic valve. In some implementations, the first acoustic actuator and/or the second acoustic actuator and/or the third acoustic actuator comprises an acoustic transducer. In some implementations, at least one of the first acoustic actuator, the second acoustic actuator, and the third acoustic actuator comprises an acoustic valve and at least another one of the first acoustic actuator, the second acoustic actuator, and the third acoustic actuator comprises an acoustic transducer. In some implementations, an acoustic actuator provided at an acoustic port acoustically coupling the first chamber and the second chamber comprises an additional acoustic transducer and an acoustic actuator provided at an acoustic port acoustically coupling the first chamber and the ambient environment and/or the second chamber and the ambient environment comprises an acoustic valve. In this way, different types of acoustic actuators can be exploited for a more comprehensive adjustment of the characteristics of the sound output.

In some implementations, the hearing device comprises a controller, in particular an electric controller providing a control signal. The controller can be configured to control the changing of the acoustic property, in particular of the first acoustic port and/or the second acoustic port and/or the third acoustic port. To this end, the controller can be operatively connected to at least one of the first acoustic actuator, the second acoustic actuator, and the third acoustic actuator. The controller can be configured to provide a control signal to the respective acoustic actuator. The controller can be provided at the housing and/or remote from the housing. In particular, the controller can be implemented in a communication device such as a smartphone. The controller can comprise a user interface allowing a user to effectuate the changing of the acoustic property of at least one acoustic port via the controller. In addition or alternatively, the controller can be configured to control the changing of the acoustic property independent from a user interaction. The controller can comprise a processing unit configured to identify a momentary hearing situation and to provide a control signal based on the momentary hearing situation.

In some implementations, the hearing device comprises at least one detector sensitive to a momentary hearing situation. The controller can be operatively connected to the detector. The controller can be configured to provide a control signal to the respective acoustic actuator depending on a detection signal provided by the detector. The detector can comprise a microphone configured to be located at an inner region of the ear canal when the hearing device is partially inserted into the ear canal. In this way, acoustic conditions in the inner region of the ear canal can be detected. The detector can comprise a microphone configured to be located in the ambient environment outside the ear canal when the hearing device is partially inserted into the ear canal. In this way, acoustic conditions in the ambient environment can be detected, in particular a sound field in the ambient environment. For instance, an ambient sound level and/or a communication with a person can thus be detected. The detector can comprise an own voice detector. In this way, a speech activity of the user can be detected. The detector can comprise a humidity sensor configured to detect a humidity level inside the ear canal. The detector can comprise a humidity sensor configured to detect a humidity level outside the ear canal. The detector can comprise a position detector. The position detector can be configured to detect a momentary position of the user. For instance, the position detector can be operatively connected to a global positioning system (GPS). The detector can comprise a movement detector. The movement detector can be configured to detect a movement of the user, in particular walking and/or running and/or head turns of the user. For instance, the position detector can be an accelerometer. The detector can comprise a temperature detector. The temperature detector can be configured to detect a temperature of the ambient environment and/or a body temperature of the user. The detector can comprise an optical detector, in particular a camera. The detector can comprise an altimeter. The altimeter can be configured to detect an altitude of the user. The detector can comprise a barometric pressure gauge. The pressure gauge can be configured the detect an air pressure in the ambient environment. The detector can comprise a wind detector. The wind detector can be configured to detect a wind activity in the ambient environment. The detector can comprise a medical detector configured to detect a medical condition of the user and/or a parameter related to the health of the user. The medical detector can comprise a tremor detector configured to detect a tremor related to Parkinson's disease. The medical detector can comprise a heartbeat sensor and/or a blood pressure detection unit and/or a blood sugar detection unit. The controller can be configured to execute the above described method of operating the hearing device.

In some implementations, the method of operating the hearing device comprises actively controlling the acoustic actuator to change said acoustic property depending on at least one of the following detected parameters:
a sound detected in the ambient environment, in particular a sound level and/or a sound field and/or a conversation involving people speaking to a user of the hearing device;
a sound detected in the ear canal;
an own voice activity of the user;
a humidity level, in particular inside the ear canal and/or outside the ear canal;
a temperature level, in particular a temperature of the ambient environment and/or a body temperature of the user;
a local position of the user;
an altitude of the user;
a movement of the user, in particular walking and/or running and/or head turns and/or a momentary velocity value and/or a momentary acceleration value of the user;
a medical condition of the user, in particular a tremor related to Parkinson's disease;
a parameter related to the health of the user, in particular a pulse and/or blood pressure and/or a blood glucose level;
a barometric pressure of the ambient environment; and
a wind activity in the ambient environment.

The parameters can be detected by the hearing device, based on input from a user, or based on input from another device. The hearing device can have a pressure sensor, humidity sensor, temperature sensor, accelerometer, barometer, or medical sensor (e.g., PPG, EEG, pulse sensor). The hearing device can also use digital signal processing techniques to detect wind noise.

In some implementations, the hearing device comprises a circuit, in particular a processing unit, configured to provide an active noise control (ANC) of the sound waves released through the sound outlet. At least one of the first acoustic actuator, the second acoustic actuator, and the third acoustic actuator can be operatively connected to the ANC circuit. The ANC circuit can thus be configured to provide a noise cancellation via the acoustic actuator changing the acoustic property of the acoustic port. For instance, the acoustic actuator can be an acoustic transducer providing a noise cancellation sound. The ANC circuit can be operatively connected to an inner microphone configured to be located at an inner region of the ear canal when the hearing device is partially inserted into the ear canal. The inner microphone can be an ear canal microphone. The ANC circuit can comprise an active feedback loop between the acoustic actuator and the inner microphone. The ANC circuit can be operatively connected to an outer microphone configured to be located in the ambient environment when the hearing device is partially inserted into the ear canal. The ANC circuit can comprise an active feedforward loop between the acoustic actuator and the outer microphone. The inner microphone and/or the outer microphone can be configured to detect noise information.

### BRIEF DESCRIPTION OF THE DRAWINGS

Reference will now be made in detail to embodiments, examples of which are illustrated in the accompanying drawings. In the drawings:

FIGS. 1-9 each schematically illustrate a respective hearing device partially inserted into an ear canal, the hearing device comprising a first chamber and a second chamber acoustically coupled via an acoustic transducer and at least one acoustic port provided with an acoustic actuator, in accordance with some embodiments of the present disclosure;

FIG. 10 schematically illustrates a hearing device comprising a first chamber and a second chamber acoustically coupled via an acoustic transducer provided in a transducer housing, in accordance with some embodiments of the present disclosure;

FIGS. 11, 12 schematically illustrate a hearing device comprising a first chamber and a second chamber acoustically coupled via an acoustic transducer, wherein acoustic ports of the hearing device are provided with an acoustic valve, in accordance with some embodiments of the present disclosure; and

FIG. 13 schematically illustrates a hearing device comprising a first chamber and a second chamber acoustically coupled via an acoustic transducer, wherein acoustic ports of the hearing device are provided with an acoustic valve, in accordance with some embodiments of the present disclosure.

### DETAILED DESCRIPTION OF THE DRAWINGS

In the following detailed description, numerous specific details are set forth in order to provide a thorough understanding of the subject matter herein. However, it will be apparent to one of ordinary skill in the art that the subject matter may be practiced without these specific details. In other instances, well known methods, procedures, techniques, components, and systems have not been described in detail so as not to unnecessarily obscure features of the embodiments. In the following description, it should be understood that features of one embodiment may be used in combination with features from another embodiment where the features of the different embodiment are not incompatible. The ensuing description provides some embodiment(s), and is not intended to limit the scope, applicability or configuration. Various changes may be made in the function and arrangement of elements without departing from the scope of the present disclosure as set forth herein.

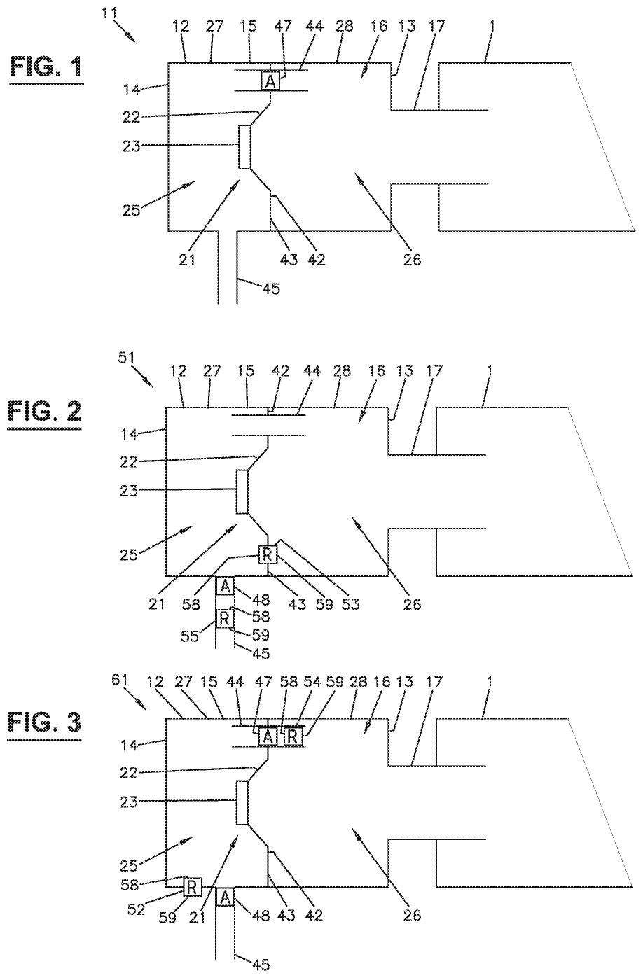

FIG. 1 schematically illustrates a hearing device 11 partially inserted into an ear canal 1. Hearing device 11 comprises a housing 12. Housing 12 comprises a front wall 13, a rear wall 14 opposing front wall 13, and a side wall 15 connecting front wall 13 and rear wall 14. Front wall 12 faces ear canal 1. Housing 12 encloses an inner volume 16. An acoustic transducer 21 is provided inside inner volume 16. Acoustic transducer 21 comprises an oscillator element 22 operatively connected to an oscillation drive 23. Oscillation drive 23 is configured to generate vibrations of oscillator element 22 such that oscillator element 22 produces sound waves emanating from oscillator element 22. Oscillator element 22 can be a diaphragm, membrane, and/or the like. Oscillation drive 23 can comprise a coil assembly for generating a magnetic field driving oscillator element 22 and a flexible suspension for oscillator element 22. The sound waves produced by oscillator element 22 propagate inside inner volume 16. Inner volume 16 thus provides an acoustic pathway for the sound waves.

Housing 12 comprises a sound outlet 17. Sound outlet 17 leads from inner volume 16 to an exterior of housing 12 such that sound outlet 17 is configured to release sound waves from inner volume 16 to the exterior. Sound outlet 17 extends the acoustic pathway for the sound waves from inner volume 16 to the exterior of housing 12. Inner volume 16 is acoustically coupled to the exterior via sound outlet 17. Sound outlet 17 is arranged in front of oscillator element 22. Oscillator element 22 faces sound outlet 17. Sound outlet 17 is fixed to front wall 13. Sound outlet 17 is a tubular member, in particular a spout, having an open rear end adjoining an aperture in front wall 13 and an open front end opposing the rear end. The open front end is free such that the sound waves can be released from housing 12 to the exterior through the open front end of sound outlet 17. Sound outlet 17 can be partially inserted into ear canal 1. After insertion, a portion of sound outlet 17 comprising the open front end is positioned in an inner region of ear canal 1 and a portion of housing 12 enclosing inner volume 16 is located outside ear canal 1 in an ambient environment. Sound outlet 17 is therefore configured to release sound waves into ear canal 1. Sound outlet 17 is further configured to contact an ear canal wall of ear canal 1. In this way, sound outlet 17 can form an acoustical seal with the ear canal wall. The acoustical seal can acoustically isolate the open front end of sound outlet 17 in ear canal 1 from the ambient environment outside ear canal 1, at least to some extent. In this way, ambient sound from the ambient environment outside the ear canal can be at least partially blocked from entering an inner region of ear canal 1.

Acoustic transducer 21 is provided inside housing 12 such that oscillator element 22 separates inner volume 16 into a first chamber 25 and a second chamber 26. Oscillator element 22 is arranged at a center portion of inner volume 16 with respect to a middle axis of inner volume 16. The middle axis extends longitudinally through a cross-sectional center of housing 12 along the acoustical pathway. Oscillator element 22 thus separates inner volume 16 into first chamber 25 and second chamber 26 at the center portion of inner volume 16. A partition 42 is provided between first chamber 25 and second chamber 26. Partition 42 comprises oscillator element 22. Partition 42 further comprises a wall section 43 surrounding an outer circumference of oscillator element 22. Surrounding wall section 43 separates inner volume 16 into first chamber 25 and second chamber 26 at an outer portion of inner volume 16. The outer portion of inner volume 16 has a radial distance with respect to the middle axis of inner volume 16. Surrounding wall section 43 comprises an inner edge adjoining oscillator element 22 and an outer edge adjoining side wall 15. Partition 42 extends over an area substantially covering a complete cross-section of inner volume 16. Partition 42 thus separates first chamber 25 and second chamber 26 substantially across inner volume 16. Housing 12 comprises a first housing portion 27 enclosing first chamber 25. First housing portion 27 comprises rear wall 14 and a portion of side wall 15. Housing 12 comprises a second housing portion 28 enclosing second chamber 26. Second housing portion 28 comprises front wall 13 and a portion of side wall 15.

Oscillator element 22 provides an acoustical coupling between first chamber 25 and second chamber 26. Sound waves can traverse partition 42 through oscillator element 22. Oscillator element 22 is configured to transfer pressure variations caused by the sound waves between first chamber 25 and second chamber 26. An inner acoustic port 44 is positioned between first chamber 25 and second chamber 26. Inner acoustic port 44 provides an acoustical coupling between first chamber 25 and second chamber 26, in addition to the acoustical coupling provided by oscillator element 22. Inner acoustic port 44 can comprise an aperture in partition 42, in particular a tubular member extending between first chamber 25 and second chamber 26. Inner acoustic port 44 can also comprise another oscillator element in partition 42, in addition to oscillator element 22 of acoustic transducer 21. The inner acoustic port 44 can allow a pressure equalization between first chamber 25 and second chamber 26. Inner acoustic port 44 can provide an acoustic mass. The acoustic mass can be determined, for instance, by selecting a length and/or a cross sectional size of a tubular member and/or a thickness and/or a mass of an oscillator element provided at inner acoustic port 44. The additional acoustical coupling provided by inner acoustic port 44 can have an impact on the acoustic pathway, in particular an acoustic impedance of the acoustic pathway and a resulting output impedance of hearing device 11, inside inner volume 16 as compared to an acoustical coupling solely provided by oscillator element 22.

An outer acoustic port 45 is positioned between first chamber 25 and the ambient environment outside housing 12. Outer acoustic port 45 constitutes a first acoustic port and inner acoustic port 44 constitutes a second acoustic port of hearing device 11. Outer acoustic port 45 provides an acoustical coupling between first chamber 25 and the ambient environment. Outer acoustic port 45 is included in the first housing portion 27 enclosing first chamber 25. Outer acoustic port 45 can comprise an aperture in housing 12, in particular a tubular member extending between first chamber 25 and the ambient environment, and/or an oscillator element between first chamber 25 and the ambient environment. Outer acoustic port 45 can thus provide an acoustic mass. The acoustic mass can be determined, for instance, by selecting a length and/or a cross sectional size of a tubular member and/or a thickness and/or a mass of an oscillator element provided at outer acoustic port 45. The acoustical coupling provided by outer acoustic port 45 can affect the acoustic pathway inside inner volume 16, in particular the acoustic impedance of the acoustic pathway, by providing a pressure equalization between first chamber 25 and the ambient environment. Moreover, the impact of the acoustical coupling between first chamber 25 and the ambient environment via outer acoustic port 45 on the acoustic pathway can be extended to second chamber 26 by the acoustical coupling between first chamber 25 and second chamber 26 via inner acoustic port 44. First chamber 25 and second chamber 26 can acoustically communicate with each other via inner acoustic port 44 and with the ambient environment via outer acoustic port 45. In this way, characteristics of the sound waves released through sound outlet 17 such as a desired frequency output can be set by the acoustic couplings. The characteristics of the sound waves can comprise, for instance, a certain frequency output and/or sound volume and/or fraction of ambient sound passing from the ambient environment through device 11 into ear canal 1.

An acoustic actuator 47 is provided at inner acoustic port 44. For instance, inner acoustic port 44 can comprise an aperture and acoustic actuator 47 can be positioned inside the aperture in order to change an effective size of the aperture. Acoustic actuator 47 can also be operationally connected to inner acoustic port 44. For instance, inner acoustic port 44 can comprise an oscillator element and acoustic actuator 47 can be configured to drive the oscillator element to produce sound waves. Acoustic actuator 47 is thus configured to change an acoustic property of inner acoustic port 44. Changing the acoustic property of inner acoustic port 44 accordingly changes the acoustic pathway inside inner volume 16, in particular the acoustic impedance. Thus, by changing the acoustic property of inner acoustic port 44, characteristics of the sound waves released through sound outlet 17, such as an output impedance and/or a frequency output and/or a sound volume and/or a fraction of ambient sound transmitted into ear canal 1, can be adjusted. Moreover, changing the acoustic property of inner acoustic port 44 can also have an indirect impact on the acoustic coupling of inner volume 16 to the ambient environment via outer acoustic port 45 because changes of the acoustic pathway inside inner volume 16 can change the acoustic interaction with the ambient environment.

The changing of the acoustic property of inner acoustic port 44 by acoustic actuator 47 thus allows to modify characteristics of the sound waves released through sound outlet 17 depending on an actual hearing situation in a dynamic way. For instance, in a hearing situation including streaming of a sound signal reproduced by acoustic transducer 21, a setting of acoustic actuator 47 can be favourable in which only a rather restricted acoustic communication between first chamber 25 and second chamber 26 can occur such that a transmission of ambient sound to the ear canal can be suppressed. In a hearing situation including a conversation and/or an own voice activity of the wearer of hearing device 11, a setting of acoustic actuator 47 can be favourable in which a rather strong acoustic communication between first chamber 25 and second chamber 26 can occur such that ambient sound can effectively reach the inner ear canal region through sound outlet 17 and/or occlusion effects can be avoided. Moreover, a desired acoustic impedance and/or frequency response and/or overall sound perception can be variably adjusted depending on a respective hearing situation.

FIG. 2 schematically illustrates a hearing device 51 partially inserted into ear canal 1. Corresponding features with respect to the previously described embodiments of hearing device 11 are illustrated by the same reference numerals. Hearing device 51 comprises an acoustic actuator 48 provided at a first acoustic port formed by outer acoustic port 45. A second acoustic port formed by inner acoustic port 44 is provided in a static configuration without an acoustic actuator. Acoustic actuator 48 is configured to change an acoustic property of outer acoustic port 45 in order to change the acoustic pathway inside inner volume 16 and thus the characteristics of the sound waves released through sound outlet 17. Changing the acoustic property of outer acoustic port 45 can thus have a direct impact on the acoustic coupling of first chamber 25 to the ambient environment via outer acoustic port 45 and an indirect impact on the acoustic coupling of second chamber 26 to the ambient environment via the acoustic coupling of second chamber 26 to first chamber 25 via inner acoustic port 44. In this way, changing the acoustic property of outer acoustic port 45 by acoustic actuator 48 can be exploited to dynamically adapt the characteristics of the sound waves released through sound outlet 17 to an actual hearing situation.

An acoustic resistance 55 is provided between first chamber 25 and the ambient environment outside inner volume 16. Acoustic resistance 55 is provided at outer acoustic port 45. Acoustic resistance 55 thus constitutes an outer acoustic resistance of first chamber 25. Acoustic resistance 55 comprises a first terminal 58 and a second terminal 59. Acoustic resistance 55 is configured to attenuate a sound pressure of sound waves propagating between first terminal 58 and second terminal 59. The attenuation of the sound waves can be provided by a sound resistive body between first terminal 58 and second terminal 59. The sound resistive body can comprise, for instance, a grid structure such as a wire mesh and/or a damping material such as a cloth. First terminal 58 is oriented towards first chamber 25.

Second terminal 59 is oriented towards the ambient environment outside inner volume 16. Acoustic resistance 55 is positioned such that it provides an acoustical coupling between first chamber 25 and the ambient environment. Acoustic resistance 55 thus provides an acoustical coupling between two volume portions, namely first chamber 25 and the ambient environment, corresponding to the volume portions acoustically coupled by outer acoustic port 45. Acoustic resistance 55 can allow a damping of resonances over a defined frequency range, for instance a damping of high frequency and/or low frequency resonances. In this way, a frequency output of hearing device 51 can be reduced at a desired frequency range and/or increased at a desired frequency range relative to another frequency range. The frequency output can be defined by amplitudes of a frequency spectrum of the sound waves released through sound outlet 17.

Acoustic resistance 55 is placed in series with acoustic actuator 48 at outer acoustic port 45. In some implementations, acoustic resistance 55 is placed at a larger distance from first chamber 25 than acoustic actuator 48, in particular such that first terminal 58 of acoustic resistance 55 faces acoustic actuator 48. In some implementations, acoustic resistance 55 is placed closer to first chamber 25 than acoustic actuator 48, in particular such that second terminal 59 of acoustic resistance 55 faces acoustic actuator 48. In some implementations, acoustic resistance 55 is integrated in acoustic actuator 48. The series arrangement of acoustic resistance 55 and acoustic actuator 48 can allow to change the impact of acoustic resistance 55 on the acoustic pathway inside inner volume 16 by changing an acoustic property of outer acoustic port 45 by acoustic actuator 48. The acoustic coupling provided by acoustic resistance 55 can thus depend on changes of the acoustic coupling at outer acoustic port 45 provided by acoustic actuator 48. In particular, an impact of acoustic resistance 55 on the frequency output of hearing device 51 can be modified by acoustic actuator 48. The frequency output can thus be dynamically adjusted to an actual hearing situation.

Outer acoustic resistance 55 of first chamber 25 is a first acoustic resistance. A second acoustic resistance 53 is provided between first chamber 25 and second chamber 26. Second acoustic resistance 53 thus constitutes an inner acoustic resistance between first chamber 25 and second chamber 26. Inner acoustic resistance 53 is provided in partition 42. Inner acoustic resistance 53 comprises a first terminal 58 and a second terminal 59, corresponding to outer acoustic resistance 55, and is configured to attenuate sound waves between first terminal 58 and second terminal 59. First terminal 58 of inner acoustic resistance 53 is oriented towards first chamber 25. Second terminal 59 of inner acoustic resistance 53 is oriented towards second chamber 26. Acoustic resistance 53 is positioned such that it provides an acoustical coupling between first chamber 25 and second chamber 26. Acoustic resistance 53 thus provides an acoustical coupling between two volume portions, namely first chamber 25 and second chamber 26, corresponding to the volume portions acoustically coupled by inner acoustic port 44. Acoustic resistance 53 is separate from inner acoustic port 44. Acoustic resistance 53 is placed in parallel to inner acoustic port 44. The acoustic coupling provided by acoustic resistance 53 can thus be autonomous from the acoustic coupling provided at inner acoustic port 44. This can be favorable to provide a desired basic frequency response of hearing device 51, in particular to provide a basic frequency behavior that can be further tuned by the series arrangement of outer acoustic actuator 48 and outer acoustic resistance 55 depending on an actual hearing situation.

FIG. 3 schematically illustrates a hearing device 61 partially inserted into ear canal 1. Corresponding features with respect to previously described embodiments of a hearing device are illustrated by the same reference numerals. Hearing device 61 comprises acoustic actuator 48 at outer acoustic port 45 as a first acoustic actuator. Hearing device 61 comprises acoustic actuator 47 at inner acoustic port 44 as a second acoustic actuator. First acoustic actuator 48 is configured to change an acoustic property of outer acoustic port 45. Second acoustic actuator 47 is configured to change an acoustic property of inner acoustic port 44. By employing two acoustic actuators 47, 48, in particular first acoustic actuator 48 at first acoustic port 45 and second acoustic actuator 47 at second acoustic port 44, characteristics of the sound waves released through sound outlet 17 can be modified in a more comprehensive and/or more precise way appropriate to a respective hearing situation.

Hearing device 61 further comprises an acoustic resistance 52 provided between first chamber 25 and the ambient environment outside inner volume 16. Acoustic resistance 52 thus constitutes an outer acoustic resistance of first chamber 25. Acoustic resistance 52 can substantially correspond to outer acoustic resistance 55 of hearing device 51 described above, except that it is provided separate from outer acoustic port 45. Acoustic resistance 52 is included in first housing portion 27 enclosing first chamber 25. First terminal 58 of acoustic resistance 52 is oriented towards first chamber 25. Second terminal 59 of acoustic resistance 52 is oriented towards the ambient environment outside inner volume 16. Acoustic resistance 52 is positioned such that it provides an acoustical coupling between first chamber 25 and the ambient environment. Acoustic resistance 52 thus provides an acoustical coupling between two volume portions, namely first chamber 25 and the ambient environment, corresponding to the volume portions acoustically coupled by outer acoustic port 45.

Acoustic resistance 52 is placed in parallel to outer acoustic port 45. The acoustic coupling provided by acoustic resistance 52 can thus be autonomous from the acoustic coupling provided at outer acoustic port 45, in particular changes of the acoustic coupling effectuated by acoustic actuator 48. In particular, an impact of acoustic resistance 52 on the frequency output of hearing device 61 can thus be provided in a static configuration which does not directly depend on changes at outer acoustic port 45 by acoustic actuator 48. This can be exploited to provide a desired basic frequency response of hearing device 61 by acoustic resistance 52, in particular to provide a basic frequency behavior that can be further tuned by acoustic actuators 47, 48 with regard to a momentary hearing situation.

Outer acoustic resistance 52 of first chamber 25 is a first acoustic resistance. A second acoustic resistance 54 is provided between first chamber 25 and second chamber 26. Acoustic resistance 52 can substantially correspond to inner acoustic resistance 53 of hearing device 51 described above, except that it is provided at inner acoustic port 44. Acoustic resistance 54 thus provides an acoustical coupling between two volume portions, namely first chamber 25 and second chamber 26, corresponding to the volume portions acoustically coupled by inner acoustic port 44. Acoustic resistance 54 is placed in series with acoustic actuator 47 at inner acoustic port 44. First terminal 58 of acoustic resistance 54 is oriented towards first chamber 25. Second terminal 59 of acoustic resistance 54 is oriented towards second chamber 26. In some implementations, acoustic resistance 54 is placed closer to first chamber 25 than acoustic actuator 47, in particular such that second terminal 59 of acoustic resistance 54 faces acoustic actuator 47. In some implementations, acoustic resistance 54 is placed closer to second chamber 26 than acoustic actuator 47, in particular such that first terminal 58 of acoustic resistance 54 faces acoustic actuator 47. In some implementations, acoustic resistance 54 is integrated in acoustic actuator 47. The acoustic coupling provided by acoustic resistance 54 can thus depend on changes of the acoustic coupling at inner acoustic port 44 effectuated by acoustic actuator 47, which can be dynamically matched to a current hearing situation.

Acoustic resistance 55 is placed in series with acoustic actuator 48 at outer acoustic port 45. In some implementations, acoustic resistance 55 is placed at a larger distance from first chamber 25 than acoustic actuator 48, in particular such that first terminal 58 of acoustic resistance 55 faces acoustic actuator 48. In some implementations, acoustic resistance 55 is placed closer to first chamber 25 than acoustic actuator 48, in particular such that second terminal 59 of acoustic resistance 55 faces acoustic actuator 48. The series arrangement of acoustic resistance 55 and acoustic actuator 48 can allow to change the impact of acoustic resistance 55 on the acoustic pathway inside inner volume 16 by changing an acoustic property of outer acoustic port 45 by acoustic actuator 48. The acoustic coupling provided by acoustic resistance 55 can thus depend on the variable acoustic coupling provided by acoustic actuator 48. In particular, an impact of acoustic resistance 55 on the frequency output and/or on the output impedance of hearing device 51 can be modified by acoustic actuator 48. The frequency output can thus be dynamically adjusted to an actual hearing situation.

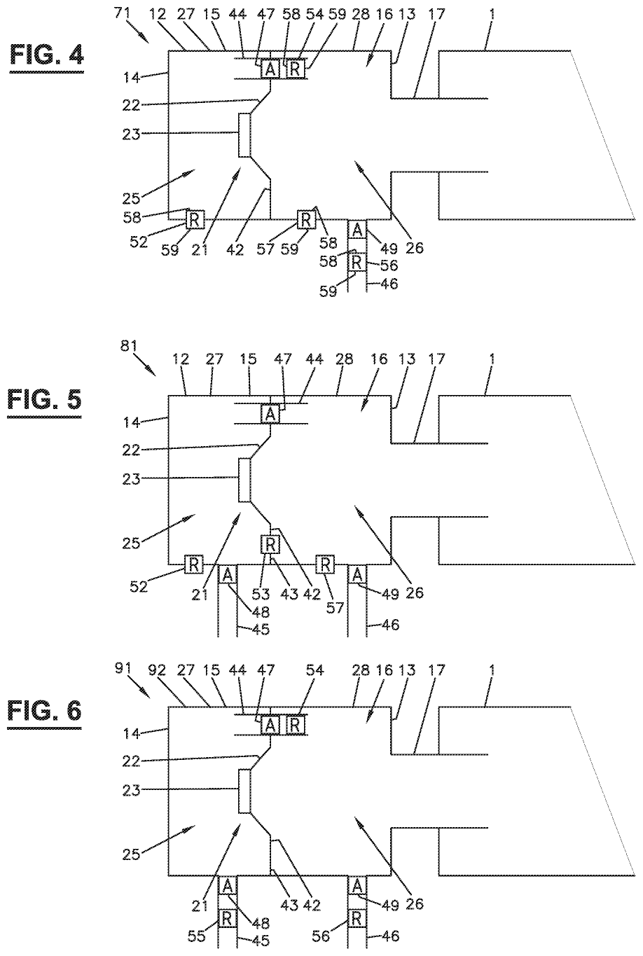

FIG. 4 schematically illustrates a hearing device 71 partially inserted into ear canal 1. Corresponding features with respect to previously described embodiments of a hearing device are illustrated by the same reference numerals. An outer acoustic port 46 is positioned between second chamber 26 and the ambient environment outside housing 12. Outer acoustic port 46 constitutes a first acoustic port and inner acoustic port 44 constitutes a second acoustic port of hearing device 71. Outer acoustic port 46 provides an acoustical coupling between second chamber 26 and the ambient environment. Outer acoustic port 46 is included in the second housing portion 28 enclosing second chamber 26. Outer acoustic port 46 can comprise an aperture in housing 12, in particular a tubular member extending between second chamber 26 and the ambient environment, and/or an oscillator element between second chamber 26 and the ambient environment. Outer acoustic port 46 can provide an acoustic mass. The acoustic mass can be determined, for instance, by selecting a length and/or a cross sectional size of a tubular member and/or a thickness and/or a mass of an oscillator element provided at outer acoustic port 46. The effect of the acoustical coupling between second chamber 26 and the ambient environment via outer acoustic port 46 on the acoustic pathway can be expanded to first chamber 25 by the acoustical coupling between second chamber 26 and first chamber 25 via inner acoustic port 44. First chamber 25 and second chamber 26 can acoustically communicate with each other via inner acoustic port 44 and with the ambient environment via outer acoustic port 46. Hearing device 71 comprises an acoustic actuator 49 at outer acoustic port 46 as a first acoustic actuator. Hearing device 71 also comprises acoustic actuator 47 at inner acoustic port 44 as a second acoustic actuator. Combining first acoustic actuator 49 at first acoustic port 46 and second acoustic actuator 47 at second acoustic port 44 can allow a rather extensive and accurate adjustment of characteristics of the sound waves released through sound outlet 17.

Hearing device 71 comprises an acoustic resistance 56 provided between second chamber 26 and the ambient environment outside inner volume 16. Acoustic resistance 56 can substantially correspond to outer acoustic resistance 55 of hearing device 51 described above, except that it is provided at outer acoustic port 46 acoustically coupling second chamber 26 and the ambient environment. Acoustic resistance 56 is placed in series with acoustic actuator 49. Changing an acoustic property at outer acoustic port 46 by acoustic actuator 49 can thus directly influence the acoustic coupling provided by acoustic resistance 56. Hearing device 71 comprises another acoustic resistance 57 provided between second chamber 26 and the ambient environment outside inner volume 16. Acoustic resistance 57 can substantially correspond to outer acoustic resistance 52 of hearing device 61 described above, except that it is included in second housing portion 28 separate from outer acoustic port 46. Acoustic resistance 57 is placed in parallel to outer acoustic port 46. Acoustic resistance 57 can thus provide an acoustical coupling between second chamber 26 and the ambient environment independent from outer acoustic port 46. In this way, acoustic resistances 56, 57 each provide an individual acoustical coupling between two volume portions, namely second chamber 26 and the ambient environment, corresponding to the volume portions acoustically coupled by outer acoustic port 46. Providing first acoustic resistance 56 and second acoustic resistance 56 in parallel between second chamber 26 and the ambient environment can be employed to provide a customized frequency response of hearing device 71, which can be adjusted by changing an acoustic property of outer acoustic port 46 by acoustic actuator 49. Hearing device 71 further comprises acoustic resistance 52 between first chamber 25 and the ambient environment as a third acoustic resistance. Hearing device 71 further comprises acoustic resistance 54 between first chamber 25 and second chamber 26 as a fourth acoustic resistance. In this way, desired frequency properties and/or properties of the output impedance can be further customized and dynamically adapted to a current hearing situation by changing an acoustic property of inner acoustic port 44 by acoustic actuator 47 and/or outer acoustic port 46 by acoustic actuator 49.

FIG. 5 schematically illustrates a hearing device 81 partially inserted into ear canal 1. Corresponding features with respect to previously described embodiments of a hearing device are illustrated by the same reference numerals. Hearing device 81 comprises outer acoustic port 45 acoustically coupling first chamber 25 to the ambient environment as a first acoustic port, outer acoustic port 46 acoustically coupling second chamber 26 to the ambient environment as a second acoustic port, and inner acoustic port 44 acoustically coupling first chamber 25 to second chamber 26 as a third acoustic port. Thus, an acoustic communication between first chamber 25, second chamber 26, and the ambient environment can be strongly enhanced allowing an effective customization of the acoustic pathway inside inner volume 16, in particular by affecting the acoustic impedance of the acoustic pathway inside inner volume 16. Hearing device 81 comprises acoustic actuator 48 provided at outer acoustic port 45 as a first acoustic actuator, acoustic actuator 49 provided at outer acoustic port 46 as a second acoustic actuator, and acoustic actuator 47 provided at inner acoustic port 44 as a third acoustic actuator. In this way, the acoustic communication between first chamber 25, second chamber 26, and the ambient environment can be adjusted in a comprehensive and accurate way such that the acoustic pathway inside inner volume 16, in particular the acoustic impedance of the acoustic pathway inside inner volume 16 and a resulting output impedance of hearing device 81, can be properly matched to a current hearing situation. Hearing device 81 further comprises acoustic resistance 52 placed in parallel to outer acoustic port 45 as a first acoustic resistance, acoustic resistance 57 placed in parallel to outer acoustic port 46 as a second acoustic resistance, and acoustic resistance 53 placed in parallel to inner acoustic port 44 as a third acoustic resistance. In this way, a basic frequency response and/or an output impedance of hearing device 81 can be effectively customized along the acoustic pathway inside inner volume 16.

FIG. 6 schematically illustrates a hearing device 91 partially inserted into ear canal 1. Corresponding features with respect to previously described embodiments of a hearing device are illustrated by the same reference numerals. Hearing device 91 substantially corresponds to hearing device 81 depicted in FIG. 5 with the following exceptions. The first acoustic resistance is provided by acoustic resistance 55 at outer acoustic port 45 placed in series with acoustic actuator 48, the second acoustic resistance is provided by acoustic resistance 56 at outer acoustic port 46 placed in series with acoustic actuator 49, and the third acoustic resistance is provided by acoustic resistance 54 at inner acoustic port 44 placed in series with acoustic actuator 47. An impact of acoustic resistances 54, 55, 56 on the frequency output of hearing device 91 and/or on the output impedance can thus be individually modified by the associated acoustic actuator 47, 48, 49 allowing a good adaptability to a hearing situation. Hearing device 91 further comprises a housing 92 configured to be partially inserted into ear canal 1. In particular, sound outlet 17 can be fully inserted and second housing portion 28 enclosing second chamber 26 can be at least partially inserted into ear canal 1. Thus, after insertion, at least a portion of second chamber 26 extends into ear canal 1. At least a portion of second housing portion 28 can be positioned in an inner region of ear canal 1 and first housing portion 27 enclosing first chamber 25 can be located outside ear canal 1 in the ambient environment. Housing 92 is configured to contact an ear canal wall of ear canal 1 at second housing portion 28. In this way, housing 92 can form an acoustical seal with the ear canal wall isolating the open front end of sound outlet 17 in ear canal 1 from the ambient environment outside ear canal 1, at least to some extent.

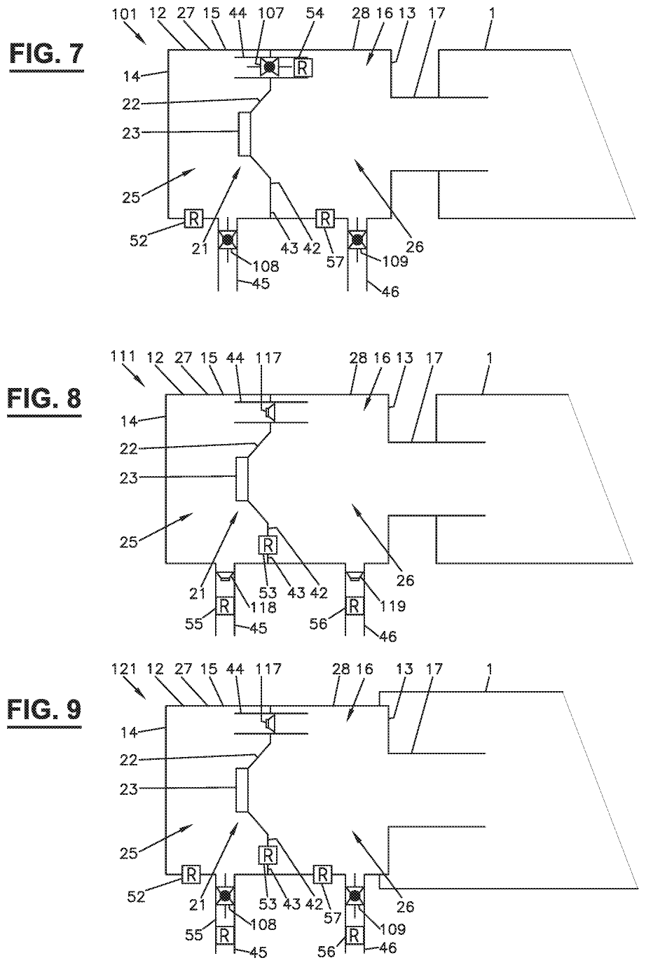

FIG. 7 schematically illustrates a hearing device 101 partially inserted into ear canal 1. Corresponding features with respect to previously described embodiments of a hearing device are illustrated by the same reference numerals. Hearing device 101 substantially corresponds to hearing device 81 depicted in FIG. 5 with the following exceptions. The third acoustic resistance is provided by acoustic resistance 54 at inner acoustic port 44. The acoustic actuators at acoustic ports 44, 45, 46 are acoustic valves 107, 108, 109. First acoustic valve 108 is provided at outer acoustic port 45, second acoustic valve 109 is provided at outer acoustic port 46, and third acoustic valve 107 is provided at inner acoustic port 44. Acoustic resistance 54 is thus connected in series with acoustic valve 107. An impact of acoustic resistance 54 on the frequency output and/or on the output impedance of hearing device 101 can thus be changed by acoustic valve 107.

Acoustic valves 107, 108, 109 are each configured to adjust an effective size of the associated acoustic port 44, 45, 46. Thus, an acoustic property of the respective acoustic port 44, 45, 46 can be changed. The effective size of inner acoustic port 44 can determine an amount by which first chamber 25 and second chamber 26 can acoustically communicate with each other via inner acoustic port 44, in particular an amount by which a pressure equalization between first chamber 25 and second chamber 26 can be obtained through inner acoustic port 44. The effective size of outer acoustic ports 45, 46 can determine an amount by which first chamber 25 and second chamber 26 can acoustically communicate with the ambient environment, in particular an amount by which a pressure equalization between the ambient environment and first chamber 25 and second chamber 26 can be obtained through each of outer acoustic ports 45, 46. For instance, the effective size can be at least one of a diameter, a length, and a cross-sectional size of the respective acoustic port 44, 45, 46, each constituting a limiting factor of an acoustic communication between first chamber 25 and/or second chamber 26 and/or the ambient environment. Acoustic valves 107, 108, 109 can be configured to change, in particular to enlarge and/or reduce, the effective size of associated acoustic port 44, 45, 46, leading for instance to an increased or decreased cross-sectional size of acoustic port 44, 45, 46. In this way, a pressure inside inner volume 16 and/or a pressure difference between chambers 25, 26 caused by the sound waves propagating at the acoustic pathway can be adjusted. Thus, an acoustic impedance of the acoustic pathway inside inner volume 16 can be changed in order to adjust an output impedance and/or frequency output through sound outlet 17.

FIG. 8 schematically illustrates a hearing device 111 partially inserted into ear canal 1. Corresponding features with respect to previously described embodiments of a hearing device are illustrated by the same reference numerals. Hearing device 111 substantially corresponds to hearing device 81 depicted in FIG. 5 with the following exceptions. The first acoustic resistance is provided by acoustic resistance 55 at outer acoustic port 45, the second acoustic resistance is provided by acoustic resistance 56 at outer acoustic port 46. The acoustic actuators at acoustic ports 44, 45, 46 are acoustic transducers 117, 118, 119. Acoustic transducers 117, 118, 119 are provided in addition to acoustic transducer 21. First additional acoustic transducer 118 is provided at outer acoustic port 45, second additional acoustic transducer 119 is provided at outer acoustic port 46, and third additional acoustic transducer 117 is provided at inner acoustic port 44. First acoustic resistance 55 is thus connected in series with acoustic transducer 118. Second acoustic resistance 56 is thus connected in series with acoustic transducer 119. An impact of acoustic resistances 55, 56 on the frequency output and/or on the output impedance of hearing device 111 can thus be changed by acoustic transducers 118, 119.

Acoustic transducers 117, 118, 119 are each configured to produce sound waves at the associated acoustic port 44, 45, 46. To this end, acoustic transducers 117, 118, 119 can each comprise an oscillator element in addition to oscillator element 22 of acoustic transducer 21 and/or an oscillation drive configured to generate vibrations of the oscillator element in addition to oscillation drive 23 of acoustic transducer 21. The respective oscillator element can be provided at the associated acoustic port 44, 45, 46. The respective oscillator element can thus provide an acoustic coupling between two volume portions, in particular between first chamber 25 and second chamber 26 and/or between first chamber 25 and the ambient environment and/or between second chamber 26 and the ambient environment. The respective oscillator element can thus be configured to produce sound waves at the associated acoustic port 44, 45, 46. Thus, an acoustic property of the respective acoustic port 44, 45, 46 can be changed, in particular by changing the sound produced by at least one of acoustic transducers 117, 118, 119. Changing the sound can comprise, for instance, changing a volume and/or output frequency of the sound waves. In this way, a pressure inside inner volume 16 and/or a pressure difference between chambers 25, 26 caused by the sound waves propagating at the acoustic pathway can be adjusted. Thus, an acoustic impedance of the acoustic pathway inside inner volume 16 can be changed in order to adjust an output impedance and/or frequency output through sound outlet 17.

FIG. 9 schematically illustrates a hearing device 121 partially inserted into ear canal 1. Corresponding features with respect to previously described embodiments of a hearing device are illustrated by the same reference numerals. Hearing device 121 substantially corresponds to hearing device 81 depicted in FIG. 5 with the following exceptions. A fourth acoustic resistance is provided by acoustic resistance 55 at outer acoustic port 45. A fifth acoustic resistance is provided by acoustic resistance 56 at outer acoustic port 46. The acoustic actuators at outer acoustic ports 45, 46 are acoustic valves 108, 109. Fourth acoustic resistance 55 is thus connected in series with acoustic valve 108. Fifth acoustic resistance 56 is thus connected in series with acoustic valve 109. The acoustic actuator at inner acoustic port 44 is acoustic transducer 117. Thus, an acoustic property of the respective acoustic port 44, 45, 46 can be changed, in particular by changing the effective size of at least one of acoustic ports 45, 46 by acoustic valves 108, 109 and/or by changing the sound produced by acoustic transducer 117 at acoustic port 44.

FIG. 10 schematically illustrates a hearing device 211 configured to be partially inserted into an ear canal. Corresponding features with respect to previously described embodiments of a hearing device are illustrated by the same reference numerals. Hearing device 211 comprises an acoustic transducer 221 and a transducer housing 227 accommodating acoustic transducer 221. Acoustic transducer 221 is a driver. Acoustic transducer 221 comprises an oscillator element 222 and an oscillation drive 223. Oscillator element 222 is a diaphragm. Oscillation drive 223 comprises a magnet 224, a voice coil 225, and a flexible suspension 226. Suspension 226 mechanically couples oscillator element 222 to voice coil 225. Voice coil 225 is constrained to move axially through a cylindrical gap in magnet 224. A variable magnetic field can be created by providing a changing electric current through voice coil 225.

The variable magnetic field can cause voice coil 225 to move back and forth inside the magnetic gap by a magnetic interaction between magnet 224 and voice coil 225. A corresponding movement of oscillator element 222 coupled to voice coil 225 can produce sound waves emanated from oscillator element 222. Transducer housing 227 comprises a transducer front port 228 and a transducer rear port 229 opposing each other. Oscillator element 222 is provided between transducer front port 228 and transducer rear port 229 such that the sound waves emanated from oscillator element 222 can propagate through transducer front port 228 and transducer rear port 229. An acoustic resistance 219 is provided in transducer rear port 229. Acoustic resistance 219 is a sound resistive body attenuating the sound waves propagating through transducer rear port 229.

Hearing device 211 comprises a housing 212 enclosing first chamber 25 at first housing portion 27 and second chamber 26 at second housing portion 28. Transducer housing 227 is integrated with housing 212 of hearing device 211. Oscillator element 222 separates inner volume 16 of housing 212 into first chamber 25 and second chamber 26. Transducer front port 228 extends through second chamber 26. Transducer rear port 229 extends through first chamber 25. Transducer front port 228 faces front wall 13 of housing 212. Sound waves propagating through transducer front port 228 are thus directed toward sound outlet 17 provided in front wall 13. Transducer rear port 229 faces rear wall 14 of housing 212. Oscillator element 222 provides an acoustical coupling between first chamber 25 and second chamber 26.

An inner acoustic port 244 is positioned between first chamber 25 and second chamber 26. Inner acoustic port 244 provides an acoustical coupling between first chamber 25 and second chamber 26, in addition to the acoustical coupling provided by oscillator element 222. Inner acoustic port 244 comprises a first channel 250 and a second channel 251 separate from one another and separate from oscillator element 222. First channel 250 and second channel 251 extend in parallel to one another between first chamber 25 and second chamber 26. First channel 250 and second channel 251 each provide an acoustical coupling between first chamber 25 and second chamber 26, in addition to the acoustical coupling provided by oscillator element 222. A partition between first chamber 25 and second chamber 26 thus comprises first channel 250, second channel 251, and oscillator element 222. First channel 250 and second channel 251 each comprise a tubular member comprising a first aperture facing first chamber 25 and a second aperture facing second chamber 26. An acoustic mass of first channel 250 and second channel 251 can be influenced by selecting a length and/or a cross sectional size of the respective tubular member. In this way, static acoustic properties of first channel 250 and second channel 251 can be set having an impact on the acoustic pathway inside inner volume 16 of housing 212, in particular an acoustic impedance of the acoustic pathway and an output impedance of hearing device 211.

An outer acoustic port 245 is positioned between first chamber 25 and the ambient environment outside housing 212. Outer acoustic port 245 is a first acoustic port of hearing device 211. Outer acoustic port 245 is provided at rear wall 14 of housing 14. Outer acoustic port 245 comprises a tubular member extending from rear wall into first chamber 25. An acoustic mass of outer acoustic port 245 can be set by selecting a length and/or a cross sectional size of the tubular member. Another outer acoustic port 246 is positioned between second chamber 26 and the ambient environment outside housing 212. Outer acoustic port 246 is a second acoustic port of hearing device 211. Outer acoustic port 246 is provided at side wall 15 of housing 14. Outer acoustic port 246 comprises a tubular member extending from side wall 15 into second chamber 26. An acoustic mass of outer acoustic port 246 can be set by selecting a length and/or a cross sectional size of the tubular member. Inner acoustic port 244 is a third acoustic port of hearing device 211.

Hearing device 211 comprises an acoustic resistance 252 placed in parallel to outer acoustic port 245 as a first acoustic resistance, an acoustic resistance 257 placed in parallel to outer acoustic port 246 as a second acoustic resistance, and an acoustic resistance 253 placed in parallel to second channel 251 of inner acoustic port 244 as a third acoustic resistance. First acoustic resistance 252 comprises a first terminal at first chamber 25 and a second terminal at the ambient environment outside inner volume 16. First acoustic resistance 252 is provided at rear wall 14. Second acoustic resistance 257 comprises a first terminal at second chamber 26 and a second terminal at the ambient environment outside inner volume 16. Second acoustic resistance 257 is provided at side wall 15. Third acoustic resistance 253 comprises a first terminal at first chamber 25 and a second terminal at second chamber 26. Third acoustic resistance 253 comprises a first terminal at first chamber 25 and a second terminal at second chamber 26. Third acoustic resistance 253 is provided at first channel 250 of inner acoustic port 244. Hearing device 211 comprises a fourth acoustic resistance 255 at first acoustic port 245, a fifth acoustic resistance 256 at second acoustic port 246, and a sixth acoustic resistance 254 at second channel 251 of third acoustic port 246. Fourth acoustic resistance 255 and fifth acoustic resistance 256 each comprise a first terminal oriented toward inner volume 16 and a second terminal oriented toward the ambient environment outside inner volume 16. Sixth acoustic resistance 254 comprises a first terminal oriented toward first chamber 25 and a second terminal oriented toward second chamber 26. Fourth acoustic resistance 255 is placed in parallel to first acoustic resistance 252. Fifth acoustic resistance 256 is placed in parallel to second acoustic resistance 257. Sixth acoustic resistance 254 is placed in parallel to third acoustic resistance 253. Hearing device 211 further comprises acoustic actuator 48 provided at first acoustic port 245 as a first acoustic actuator, acoustic actuator 49 provided at second acoustic port 246 as a second acoustic actuator, and acoustic actuator 47 provided at second channel 251 of third acoustic port 246 as a third acoustic actuator. Fourth acoustic resistance 255 is placed in series with first acoustic actuator 48. Fifth acoustic resistance 256 is placed in series with second acoustic actuator 49. Sixth acoustic resistance 254 is placed in series with third acoustic actuator 47. Acoustic resistances 252, 253, 254, 255, 256, 257 each comprise a sound resistive body, in particular a grid structure and/or a damping material, attenuating the sound waves propagating between the first terminal and second terminal of the respective acoustic resistance 252-257.

A controller 261 is operatively connected to first acoustic actuator 48, second acoustic actuator 49, and third acoustic actuator 47. Controller 261 is thus configured to control the changing of an acoustic property of first acoustic port 245 by first acoustic actuator 48 and/or of second acoustic port 246 by second acoustic actuator 49 and/or of third acoustic port 250 by third acoustic actuator 47. Controller 261 can be correspondingly provided in the previously described embodiments 11, 51, 61, 71, 81, 91, 101, 111, 121 of the hearing device. In particular, controller 261 can be operatively connected with at least one of acoustic actuators 47, 48, 49, 107, 108, 109, 117, 118, 119 by a wired and/or wireless connection. Controller 261 can be provided at housing 12, 92, 212 and/or separate from housing 12, 92, 212. In particular, controller 261 can be provided in a communication device operable by a user of the hearing device, for instance a smartphone. Characteristics of the sound waves released through sound outlet 17, in particular a desired acoustic impedance and/or frequency response and/or overall sound perception, can thus be variably adjusted via controller 261 depending on a momentary hearing situation.

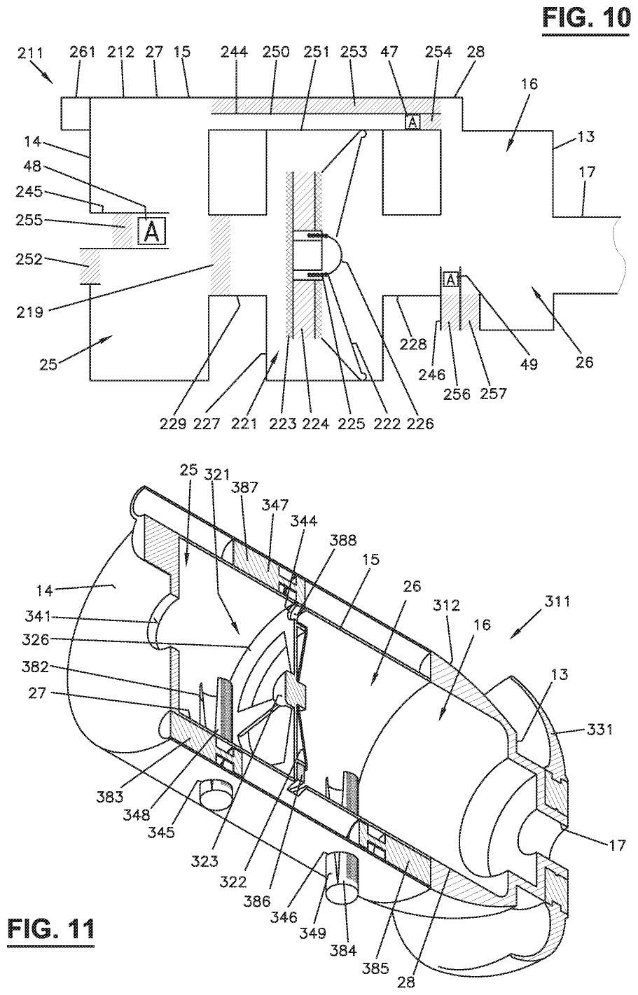

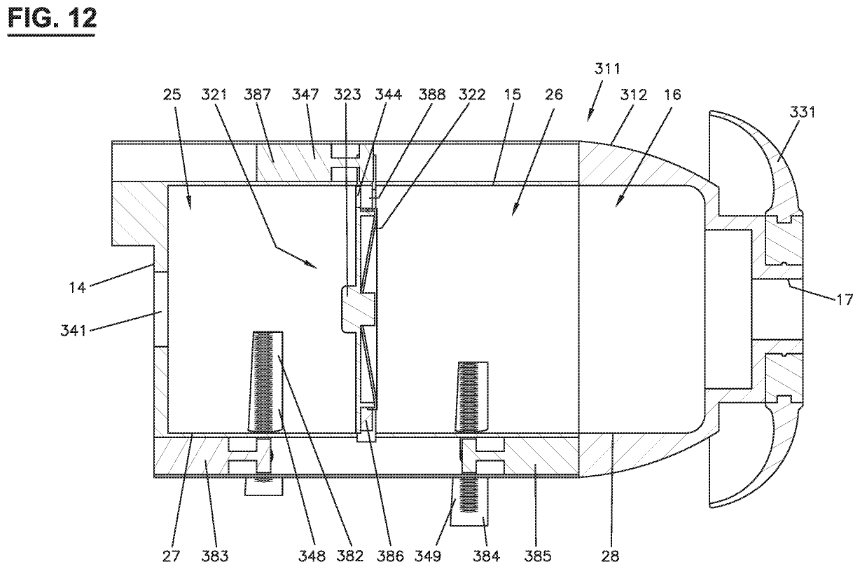

FIGS. 11 and 12 schematically illustrate a hearing device 311 configured to be partially inserted into an ear canal. Corresponding features with respect to previously described embodiments of a hearing device are illustrated by the same reference numerals. Hearing device 311 comprises a housing 312 accommodating an acoustic transducer 321. A flexible member 331 is provided at a front portion of housing 312. Flexible member 331 has an annular shape. Flexible member 331 is attached to sound outlet 17. To this end, a mounting ring is provided between flexible member 331 and sound outlet 17. Flexible member 331 is configured to conform to an ear canal wall upon insertion of hearing device 311 into the ear canal. In this way, an acoustical sealing between housing 312 and the ear canal wall can be provided by flexible member 331. Sound waves can be released through sound outlet 17 to an inner region of the ear canal acoustically sealed from an ambient environment outside the ear canal by flexible member 331.

Acoustic transducer 321 comprises an oscillator element 322 configured to produce sound waves. Oscillator element 322 separates inner volume 16 of housing 312 into first chamber 25 and second chamber 26. Oscillator element 322 provides an acoustical coupling between first chamber 25 and second chamber 26. An oscillation drive 323 is operatively connected to oscillator element 322. An outer acoustic port 345 is positioned between first chamber 25 and the ambient environment outside inner volume 16. Outer acoustic port 345 is a circular opening in side wall 15 at first housing portion 27 enclosing first chamber 25. Another outer acoustic port 341 positioned between first chamber 25 and the ambient environment is provided at rear wall 14. Outer acoustic port 341 is a circular opening in rear wall 14. An outer acoustic port 346 is positioned between second chamber 26 and the ambient environment. Outer acoustic port 346 is a circular opening in side wall 15 at second housing portion 28 enclosing second chamber 26. An inner acoustic port 344 is positioned between first chamber 25 and second chamber 26. Inner acoustic port 344 is a circular opening provided in an annular portion 326 of acoustic transducer 321. Annular portion 326 surrounds oscillator element 322. A partition between first chamber 25 and second chamber 26 comprises oscillator element 322 and annular portion 326 of acoustic transducer 321. Outer acoustic port 345 is a first acoustic port, outer acoustic port 346 is a second acoustic port, inner acoustic port 344 is a third acoustic port, and outer acoustic port 341 is a fourth acoustic port of hearing device 311.

A first acoustic actuator 348 is provided at first acoustic port 345. First acoustic actuator 348 is an acoustic valve. First acoustic actuator 348 comprises a valve member 382 and a driving unit 383. Valve member 382 is a tubular member extending between first chamber 25 and the ambient environment through first acoustic port 345. Valve member 382 comprises a closed end provided in the ambient environment and an open end provided in first chamber 25. Valve member 382 comprises a cylindrical sidewall between its closed end and its open end. Valve member 382 is displaceable inside acoustic port 345 along the cylindrical sidewall. An aperture is provided in the cylindrical sidewall of valve member 382. The aperture tapers from the end of valve member 382 inside first chamber 25 toward the end of valve member 382 in the ambient environment. The aperture tapers at a linear slope. Thus, the aperture substantially has a V-shape.

Displacing valve member 382 inside acoustic port 345 in a direction from first chamber 25 toward the ambient environment thus increases a section of the aperture of valve member 382 positioned outside first chamber 25 in the ambient environment. In this way, an effective size of acoustic port 345 can be adjusted. In particular, an acoustic pathway between first chamber 25 and the ambient environment can be provided through the aperture of valve member 382. An acoustic mass of the acoustic pathway through acoustic port 345 can be reduced by displacing valve member 382 further outside first chamber 25 such that a section of the aperture located in the ambient environment is increased. An acoustic mass of the acoustic pathway through acoustic port 345 can be increased by displacing valve member 382 further inside first chamber 25 such that a section of the aperture located in the ambient environment is decreased. In this way, an acoustic property of acoustic port 345 can be continuously changed, in particular by increasing or decreasing the acoustic mass. Increasing the acoustic mass of acoustic port 345 leads to a decreased venting efficiency through acoustic port 345. Decreasing the acoustic mass of acoustic port 345 leads to an increased venting efficiency through acoustic port 345. Driving unit 383 comprises a micromotor and a gear. The micromotor drives the gear. The gear of driving unit 383 is operatively connected to a toothed surface at the cylindrical sidewall of valve member 382. A displacement of valve member 382 inside acoustic port 345 can thus be actuated by driving unit 383.

A second acoustic actuator 349 is provided at second acoustic port 346. Second acoustic actuator 349 is an acoustic valve. Second acoustic actuator 349 comprises a valve member 384 extending between second chamber 26 and the ambient environment through second acoustic port 346. Second acoustic actuator 349 further comprises a driving unit 385 configured to actuate a displacement of valve member 384 inside acoustic port 346. Valve member 384 and driving unit 385 of second acoustic actuator 349 substantially correspond to valve member 382 and driving unit 383 of first acoustic actuator 348. Thus, an acoustic property of second acoustic port 346 can be changed by increasing or decreasing an acoustic mass by a displacement of valve member 384 inside acoustic port 346. In this way, an effective size of acoustic port 346 can be adjusted.

A third acoustic actuator 347 is provided at third acoustic port 346. Third acoustic actuator 347 is an acoustic valve. Third acoustic actuator 347 comprises a valve member 386 bordering annular portion 326 of acoustic transducer 321. Valve member 386 has an annular shape. Valve member 386 surrounds oscillator element 322. Valve member 386 is rotatable around oscillator element 322 relative to annular portion 326 of acoustic transducer 321. Valve member 386 comprises a through-hole 388. A cross section of through-hole 388 substantially corresponds to a cross section of acoustic port 344. In this way, an effective size of acoustic port 344 can be adjusted by rotating valve member 386 relative to acoustic transducer 321. In particular, a decreased acoustic mass of acoustic port 344 can be set by providing valve member 386 in a rotative position in which through-hole 388 is aligned with acoustic port 344 such that acoustic port 344 is open. An increased acoustic mass of acoustic port 344 can be set by providing valve member 386 in a rotative position in which through-hole 388 is at least not fully aligned with acoustic port 344 such that acoustic port 344 is at least partially closed by valve member 386. Third acoustic actuator 347 further comprises a driving unit 387 configured to actuate a rotation of valve member 386. Driving unit 387 of third acoustic actuator 347 substantially corresponds to driving unit 383 of first acoustic actuator 348. The gear of driving unit 387 is operatively connected to a toothed surface at a circumferential edge of valve member 382.

Hearing device 311 can further comprise at least one acoustic resistance, in particular at least one acoustic resistance placed in parallel to one of acoustic ports 341, 344, 345, 346 and/or at least one acoustic resistance placed in series with one of acoustic actuators 347, 348, 349, as described above. Hearing device 311 can further comprise a controller operatively connected to acoustic actuators 347, 348, 349, as described above.

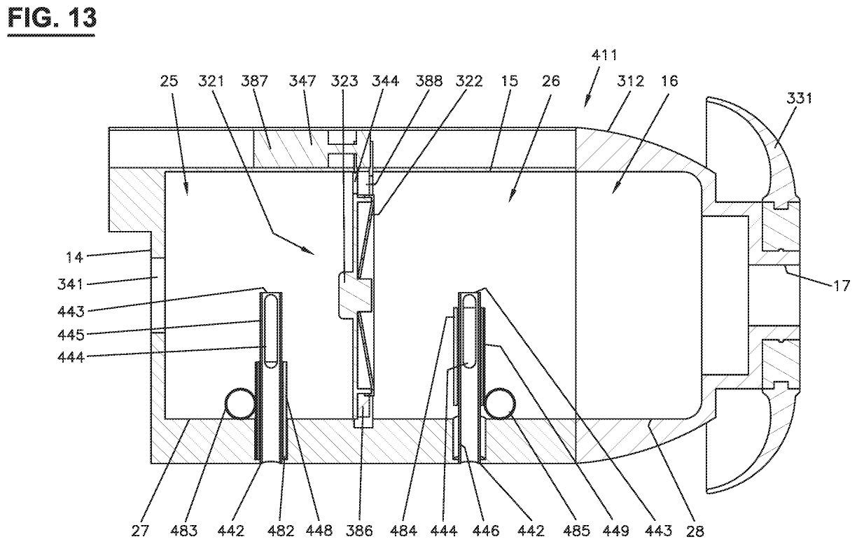

FIG. 13 schematically illustrates a hearing device 411 configured to be partially inserted into an ear canal. Corresponding features with respect to previously described embodiments of a hearing device are illustrated by the same reference numerals. Hearing device 411 substantially corresponds to hearing device 311 depicted in FIGS. 11 and 12 with the following exceptions. First acoustic port between first chamber 25 and the ambient environment is provided by a tubular member 445. First acoustic port 445 thus extends from side wall 15 into first chamber 25 at a distance from side wall 15. First acoustic port 445 comprises an open end 442 leading to the ambient environment and a closed end 443 inside first chamber 25. First acoustic port 445 comprises a cylindrical wall between open end 442 and closed end 443. An aperture 444 is provided in the cylindrical wall. First acoustic port 445 thus provides an acoustic coupling between first chamber 25 and the ambient environment through aperture 444 and open end 442 of first acoustic port 445. Second acoustic port between second chamber 26 and the ambient environment is provided by a tubular member 446. Second acoustic port 446 substantially corresponds to first acoustic port 445, wherein closed end 443 is provided inside second chamber 25 and open end 442 leads to the ambient environment. Second acoustic port 446 thus extends from side wall 15 into second chamber 26 at a distance from side wall 15. Second acoustic port 446 provides an acoustic coupling between second chamber 25 and the ambient environment through aperture 444 and open end 442 of second acoustic port 446. An acoustic mass of first acoustic port 445 and second acoustic port 446 can be influenced by selecting a length and/or a cross sectional size of the respective tubular member and/or a size of aperture 444.

A first acoustic actuator 448 is provided at first acoustic port 445. First acoustic actuator 448 is an acoustic valve. First acoustic actuator 448 comprises a valve member 482 and a driving unit 483. Valve member 482 is a tubular member enclosing a portion of first acoustic port 445 at the cylindrical wall. Valve member 482 is displaceable along the cylindrical wall of first acoustic port 445. A size of aperture 444 in first acoustic port 445 can thus be continuously adjusted, in particular increased and/or decreased, by the displacing of valve member 482. In this way, an effective size of first acoustic port 445 can be adjusted. In particular, valve member 482 can be continuously displaced in between a first position in which aperture 444 is not covered by valve member 482 such that aperture 444 is fully open and a second position in which aperture 444 is fully covered by valve member 482 such that aperture 444 is fully closed. Thus, an acoustic property, in particular an acoustic mass, of first acoustic port 445 can be continuously adjusted by a continuous displacing of valve member 482 and thus continuously changing an opening size of aperture 444. Driving unit 483 comprises a gear driven by a micromotor. The gear is operatively connected to a toothed surface at a cylindrical wall of valve member 482. A displacement of valve member 482 at acoustic port 445 can thus be actuated by driving unit 483.

A second acoustic actuator 449 is provided at second acoustic port 446. Second acoustic actuator 449 is an acoustic valve. Second acoustic actuator 449 comprises a valve member 484 enclosing a portion of second acoustic port 445 at the cylindrical wall. Valve member 484 is displaceable along the cylindrical wall of second acoustic port 446. Second acoustic actuator 449 further comprises a driving unit 485 configured to actuate a displacement of valve member 484. Valve member 484 and driving unit 485 of second acoustic actuator 449 substantially correspond to valve member 482 and driving unit 483 of first acoustic actuator 448. Thus, an acoustic property of second acoustic port 446 can be changed by increasing or decreasing an acoustic mass by a displacement of valve member 484 at acoustic port 446. In this way, an effective size of acoustic port 446 can be adjusted.

The above description of acoustic actuators 347, 348, 349, 448, 449 at acoustic ports 344, 345, 346, 445, 446 has the illustrative purpose to exemplify by means of a concrete example some embodiments of acoustic actuators configured to change an acoustic property of the respective acoustic port by adjusting an effective size of the acoustic port. The above description, however, is not intended to limit the scope of the present disclosure to those embodiments. As will be understood by a skilled person, other acoustic actuators configured to change an acoustic property of the acoustic port can be employed in place of acoustic actuators 347, 348, 349, 448, 449. For instance, acoustic actuators for adjusting an effective size of the acoustic port are also disclosed in patent application No. PCT/EP2018/069105 and in publications Nos. U.S. Pat. No. 6,549,635 B1, US 2017/0208382 A1, EP 2 164 277 A2, EP 2 835 987 A1, and EP 2 536 167 A1, which could also be employed as acoustic actuators in the above described embodiments of hearing devices 11, 51, 61, 71, 81, 91, 101, 111, 121, 211, 311, 411.

In some implementations, at least one acoustic actuator comprising an electroactive member can be provided at one of acoustic ports 344, 345, 346, 445, 446, in particular in the place of one of acoustic actuators 347, 348, 349, 448, 449. The electroactive member can be deformable by a current supplied to the electroactive member. Thus, an effective size of the acoustic port can be adjusted by a current supplied to the electroactive layer. In particular, the acoustic port can be provided in a closed state in which no current is supplied to the electroactive member such that the electroactive member has a shape covering the acoustic port. The acoustic port can be provided in an open state in which a current is supplied to the electroactive member such that the electroactive member has a shape not fully covering the acoustic port. For instance, the electroactive member can comprise an electroactive polymer and/or a piezo ceramic layer. In some implementations, at least one acoustic actuator configured to produce sound waves can be provided at one of acoustic ports 344, 345, 346, 445, 446, in particular in the place of one of acoustic actuators 347, 348, 349, 448, 449. An acoustic property of the acoustic port can thus be changed by the production of sound waves at the acoustic port, in particular such that an acoustic pressure inside inner volume 16 can be changed by the sound waves produced at the acoustic port. For instance, the acoustic actuator can be an acoustic transducer.

I/We claim:

1. A hearing device comprising:
a housing configured to be partially inserted into an ear canal;
an acoustic transducer having an oscillator element configured to produce sound waves, the housing accommodating the acoustic transducer such that the oscillator element separates an inner volume inside the housing into a first chamber and a second chamber acoustically coupled by the oscillator element;
a sound outlet configured to release sound waves into the ear canal;
a first acoustic port acoustically coupling the first chamber to an ambient environment outside the inner volume;
a second acoustic port acoustically coupling the second chamber to the first chamber or to the ambient environment; and
an acoustic actuator configured to actively modify an acoustic property of the first acoustic port or the second acoustic port.

2. The hearing device according to claim 1, wherein the acoustic actuator is a first acoustic actuator and the hearing device further comprises a second acoustic actuator, wherein the first acoustic actuator is provided at the first acoustic port and the second acoustic actuator is provided at the second acoustic port.

3. The hearing device according to claim 2, wherein the hearing device further comprises: a third acoustic port acoustically coupling the second chamber to the first chamber, the second acoustic port acoustically coupling the second chamber to the ambient environment.

4. The hearing device according to claim 3, wherein the hearing device further comprises: a third acoustic actuator provided at the third acoustic port.

5. The hearing device according to claim 1, wherein the hearing device further comprises: an acoustic resistance comprising a first terminal and a second terminal and configured to attenuate sound waves propagating between the first terminal and the second terminal, wherein the first terminal and the second terminal are positioned such that they provide an acoustical coupling between two volume portions corresponding to the volume portions acoustically coupled by the first acoustic port or the second acoustic port.

6. The hearing device according to claim 5, wherein the acoustic resistance is provided at the first acoustic port or at the second acoustic port.

7. The hearing device according to claim 5, wherein the acoustic resistance is provided in a housing portion enclosing the first chamber at a distance to the first acoustic port or in a housing portion enclosing the second chamber at a distance to the second acoustic port.

8. The hearing device according to claim 5, wherein the acoustic resistance is provided in a partition between the first chamber and the second chamber at a distance to the second acoustic port.

9. The hearing device according to claim 8, wherein the acoustic resistance is a first acoustic resistance and the hearing device further comprises a second acoustic resistance, wherein the first terminal and the second terminal of the second acoustic resistance are positioned such that they provide the acoustical coupling between the two volume portions corresponding to the volume portions acoustically coupled by the second acoustic port, wherein a first terminal and a second terminal of the first acoustic resistance are positioned such that they provide the acoustical coupling between the two volume portions corresponding to the volume portions acoustically coupled by the first acoustic port.

10. The hearing device according to claim 9, wherein the hearing device further comprises a third acoustic resistance, wherein a first terminal and a second terminal of the third acoustic resistance are positioned such that they provide the acoustical coupling between the two volume portions corresponding to the volume portions acoustically coupled by the third acoustic port.

11. The hearing device according to claim 1, wherein the inner volume inside the housing provides an acoustic pathway for sound waves produced from the oscillator element, wherein the acoustic actuator is configured to adjust an acoustic impedance of the acoustic pathway by the changing of said acoustic property of the first acoustic port or the second acoustic port.

12. The hearing device according to claim 1, wherein the acoustic actuator is configured to adjust an effective size of the first acoustic port or the second acoustic port.

13. The hearing device according to claim 1, wherein the acoustic actuator is configured to produce sound.

14. The hearing device according to claim 1, wherein the hearing device further comprises: a controller configured to control the changing of the acoustic property.

15. The hearing device according to claim 1, wherein the acoustic actuator comprises an acoustic valve or loudspeaker.

16. The hearing device according to claim 1, wherein the acoustic property is at least one of the following: output impedance, frequency output, acoustic mass, pressure difference between chambers in the hearing device or between chambers in the hearing device and the ambient environment.

17. A hearing device, the hearing device comprising:
a housing configured to be partially inserted into an ear canal;
an acoustic transducer having an oscillator element configured to produce sound waves, the housing accommodating the acoustic transducer such that the oscillator element separates an inner volume inside the housing into a first chamber and a second chamber acoustically coupled by the oscillator element;
a sound outlet configured to release sound waves into the ear canal;
a first acoustic port acoustically coupling the first chamber to an ambient environment outside the inner volume;
a second acoustic port acoustically coupling the second chamber to the first chamber or to the ambient environment;
an acoustic actuator configured to actively modify an acoustic property of the first acoustic port or the second acoustic port; and
a processor configured to electronically communicate with the acoustic actuator and a memory, the memory storing instructions to control the acoustic actuator based on a detected parameter.

18. The hearing device of claim 17, wherein the detected parameter is at least one of the following:
a sound detected in the ambient environment;
a sound detected in the ear canal;
an own voice activity of a user of the hearing device;
a humidity level inside the ear canal and/or outside the ear canal;
a temperature level of the ambient environment and/or a body temperature of the user of the hearing device;
a local position of the user;
an altitude of the user;
a movement of the user;
a medical condition of the user;
a barometric pressure of the ambient environment;
wind activity in the ambient environment; and
any combination thereof.
